(19) United States
(12) Patent Application Publication
(10) Pub. No.: US 2007/0047260 A1
(43) Pub. Date: Mar. 1, 2007

(54) BRIGHTNESS ENHANCEMENT FILM USING LIGHT CONCENTRATOR ARRAY

(76) Inventors: Junwon Lee, Webster, NY (US); David Kessler, Rochester, NY (US)

Correspondence Address: Andrew J. Anderson, Patent Legal Staff;Eastman Kodak Company, 343 State Street, Rochester, NY, 14650-2201, US

(21) Appl. No.: 11/551,316

(22) Filed: Oct. 20, 2006

Related U.S. Application Data
(63) Continuation of application No. 10/785,598, filed on Feb. 24, 2004.

(51) Int. Cl. F21V 7/04

(52) U.S. Cl. 362/617; 362/627

(57) ABSTRACT

A brightness enhancement film comprises an array of tapered structures, each said tapered structure having a light input aperture and a larger light output aperture. The inner side-wall of each said tapered structure is adapted to reflect off-axis light from the light guiding plate incident at said input aperture to said output aperture.

### CROSS-REFERENCE TO RELATED APPLICATION

This application is a continuation of U.S. Ser. No. 10/785,598 filed on Feb. 24, 2004 the contents of which are incorporated herein.

### FIELD OF THE INVENTION

The invention generally relates to brightness enhancement articles and more particularly relates to a brightness enhancement film using an array of concentrator structures for conditioning illumination for use with backlit display devices, such as laptop LCD displays.

### BACKGROUND OF THE INVENTION

While LCD displays offer a compact, lightweight alternative to CRT monitors, there are many applications for which LCD displays are not satisfactory due to a low level of brightness, or more properly, luminance. The transmissive LCD used in conventional laptop computer displays is a type of backlit display, having a light-providing surface positioned behind the LCD for directing light outwards, towards the LCD. The light-providing surface itself provides illumination that is essentially Lambertian, that is, having an essentially constant luminance over a broad range of angles. With the goal of increasing on-axis and near-axis luminance, a number of brightness enhancement films have been proposed for redirecting a portion of this light having Lambertian distribution toward normal, relative to the display surface. Among proposed solutions for brightness or luminance enhancement for use with LCD displays and with other types of backlit display types are the following:

U.S. Pat. No. 5,592,332 (Nishio et al.) discloses the use of two crossed lenticular lens surfaces for adjusting the angular range of light in an LCD display apparatus; U.S. Pat. No. 5,611,611 (Ogino et al.) discloses a rear projection display using a combination of Fresnel and lenticular lens sheets for obtaining the desired light divergence and luminance;

U.S. Pat. No. 6,111,696 (Allen et al.) discloses a brightness enhancement film for a display or lighting fixture. With the optical film disclosed in the '696 patent, the surface facing the illumination source is smooth; the opposite surface has a series of structures, such as triangular prisms, for redirecting the illumination angle. The film disclosed in the '696 patent refracts off-axis light to provide a degree of correction for directing light at narrower angles. However, this film design works best for redirecting off-axis light; incident light that is normal to the film surface may be reflected back toward the source, rather than transmitted;

U.S. Pat. No. 5,629,784 (Abileah et al.) discloses various embodiments in which a prism sheet is employed for enhancing brightness, contrast ratio, and color uniformity of an LCD display of the reflective type. In an embodiment disclosed in the '784 patent, the brightness enhancement film similar to that of the '696 patent is arranged with its structured surface facing the source of reflected light for providing improved luminance as well as reduced ambient light effects. Because this component is used with a reflective imaging device, the prism sheet of the '784 disclosure is placed between the viewer and the LCD surface, rather than in the position used for transmissive LCD systems (that is, between the light source and the LCD);

U.S. Patent Application Publication No. 2001/0053075 (Parker et al.) discloses various types of surface structures used in light redirection films for LCD displays, including prisms and other structures;

U.S. Pat. No. 5,887,964 (Higuchi et al.) discloses a transparent prism sheet having extended prism structures along each surface for improved back-light propagation and luminance in an LCD display. As is noted with respect to the '696 patent mentioned above, much of the on-axis light is reflected rather than transmitted with this arrangement. Relative to the light source, the orientation of the prism sheet in the '964 disclosure is reversed from that used in the '696 disclosure. The arrangement shown in the '964 disclosure is usable only for small, hand-held displays and does not use a Lambertian light source;

U.S. Pat. No. 6,356,391 (Gardiner et al.) discloses a pair of optical turning films for redirecting light in an LCD display, using an array of prisms, where the prisms can have different dimensions;

U.S. Pat. No. 6,280,063 (Fong et al.) discloses a brightness enhancement film with prism structures on one side of the film having blunted or rounded peaks;

U.S. Pat. No. 6,277,471 (Tang) discloses a brightness enhancement film having a plurality of generally triangular prism structures having curved facets;

U.S. Pat. No. 5,917,664 (O'Neill et al.) discloses a brightness enhancement film having “soft” cutoff angles in comparison with conventional film types, thereby mitigating the luminance change as viewing angle increases;

U.S. Pat. No. 5,839,823 (Hou et al.) discloses an illumination system with light recycling for a non-Lambertian source, using an array of microprisms; and,

U.S. Pat. No. 5,396,350 (Beeson et al.) discloses a backlight apparatus with light recycling features, employing an array of microprisms in contact with a light source for light redirection in illumination apparatus where heat may be a problem and where a relatively non-uniform light output is acceptable.

FIG. 1 shows one type of prior art solution, a brightness enhancement film 10 for enhancing light provided from a light source 18. Brightness enhancement film 10 has a smooth side 12 facing towards a light-providing surface 14, which contains a reflective surface 19, and rows of prismatic structures 16 facing an LCD component 20. This arrangement, as described in U.S. Pat. Nos. 6,111,696 and 5,629,784 (both listed above), and in 5,944,405 (Takeuchi et al.), generally works well, improving the on-axis luminance by refraction of off-axis light rays and directing a portion of this light closer to the normal optical axis. As FIG. 1 shows, off-axis rays R1 are refracted toward normal. It is instructive to note, however, that, due to total internal reflection (TIR), near-axis light ray R3 can be refracted away from normal at a more extreme angle. In addition, on-axis light ray R4 can actually be reflected back toward light-providing surface 14 for diffusion and reflection from reflective surface 19 rather than directed toward LCD component 20. This refraction of near-axis light and reflection of at least a portion of on-axis light back into light-providing surface 14 acts to adjust illumination luminance with respect to viewing angle, as is described subsequently. By the action of light-providing surface 14 and reflective surface 19, a portion of the light that is reflected back from brightness enhancement film 10 is eventually diffused and again directed outward toward the LCD component at a generally normal angle.

The purpose of brightness enhancement film 10, then, is to redirect the light that is provided over a large angular range from light-providing surface 14, so that the output light it provides to LCD component 20 is generally directed toward normal. By doing this, brightness enhancement film 10 helps to improve display luminance not only when viewed straight-on, at a normal to the display surface, but also when viewed from oblique angles.

As the viewer angle from normal increases, the perceived luminance can diminish significantly beyond a threshold angle. The graph of FIG. 2 shows a luminance curve 26 that depicts the characteristic relationship of luminance to viewer angle when using the prior art brightness enhancement film 10. As expected, luminance peaks at the normal and decreases toward a threshold cutoff angle, θcutoff, each side of normal. A slight increase occurs beyond angle θcutoff; however, this represents wasted light, not readily perceptible to the viewer due to characteristics of the LCD display itself.

With reference to luminance curve 26 in FIG. 2, one characteristic of interest is the overall shape of the curve. The luminance over a range of viewing angles is proportional to the area under the curve for those angles. Typically, the peak luminance values occur at angles near normal, as would be expected. In many applications, it is most beneficial to increase luminance within a small range of viewing angles centered about a normal.

While conventional approaches, such as those noted in the prior art disclosures mentioned hereinabove, provide some measure of brightness enhancement at low viewing angles, these approaches have some shortcomings. Some of the solutions noted above are more effective for redistributing light over a preferred range of angles rather than for redirecting light toward normal for best on-axis viewing. Prior art brightness enhancement film solutions have a directional bias, working best for redirecting light in one direction. For example, a brightness enhancement film may redirect the light path in a width direction relative to the display surface, but have little or no affect on light in the length direction. As a result, multiple orthogonally crossed sheets must be overlaid in order to redirect light in different directions, typically used for redirecting light in both horizontal and vertical directions with respect to the display surface. Necessarily, this type of approach is somewhat a compromise; such an approach is not optimal for light in directions diagonal to the two orthogonal axes.

As disclosed in the patents listed above, brightness enhancement articles have been proposed with various types of refractive surface structures formed atop a substrate material, including arrangements employing a plurality of protruding prism shapes, both as matrices of separate prism structures and as elongated prism structures, with the apex of prisms both facing toward and facing away from the light source. For the most part, prior art solutions still exhibit directional bias, requiring the use of multiple sheets in practical applications.

Parabolic reflectors are well known in various types of applications for collecting or transmitting electromagnetic energy along an axis. In room lighting applications, for example, parabolic reflectors, and reflectors whose shape approximates a parabolic shape, are positioned around a lamp or other light source to collect light and direct it outward, generally in one direction. For optimal parabolic reflection of light along an axis, the light source would be positioned at a focal point for the parabolic reflector.

More efficient light concentrators, such as compound parabolic concentrators (CPC) have been used for collecting light in various applications, particular for solar energy applications. For example, U.S. Pat. Nos. 4,002,499 and 4,003,638 (both to Winston) disclose the use of reflective parabolic concentrator elements for radiant energy collection. U.S. Pat. No. 6,384,320 (Chen) discloses the use of an array of reflective CPC devices used for a residential solar-power generation system. Light concentrators have also been used to support light sensing devices. For example, UK Patent Application GB 2 326 525 (Leonard) discloses the use of a reflective CPC array as a concentrator for obtaining light for a light sensor, such as a Charge-Coupled Device (CCD). Altogether, however, CPC and similar structures have been exploited for collecting and sensing light in various applications, rather than for achieving improved light distribution and redirection.

In spite of the concerted effort that has been expended for improving display luminance, there is still room for improvement, particularly where a high level of near-axis luminance is desired. LCD display equipment still requires multiple layers of orthogonally crossed films for enhancing brightness and improving contrast, adding complexity and bulk to display packaging. Thus, it can be seen that there is a need for a brightness enhancement film that is light-efficient and improves luminance at near-axis viewing angles.

### SUMMARY OF THE INVENTION

The invention provides a brightness enhancement film comprising an array of tapered structures, each said tapered structure having a light input aperture and a larger light output aperture, wherein the inner surface of each said tapered structure is adapted to reflect off-axis light incident at said input aperture to said output aperture. The invention also provides an illumination system, a display apparatus, a light guide plate, and a method for enhancing illuminance employing the film.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a cross-sectional side view showing a prior art brightness enhancement film used with an LCD display;

FIG. 2 is a graph showing the relationship of luminance to viewing angle for a prior art brightness enhancement film;

FIG. 3 is a perspective view of a small portion of reflective cavities in one embodiment of the present invention;

FIG. 4a is a perspective top view of a film using reflective cavities in one embodiment of the present invention;

FIG. 4b is a perspective bottom view of a film using reflective cavities in one embodiment of the present invention;

FIGS. 5a, 5b, and 5c are perspective top views showing different types of reflective structures used in alternate embodiments of the present invention;

FIG. 6 is a wire frame view of the film shown in FIGS. 3, 4, and 5;

FIG. 7 is a ray diagram showing the behavior of a reflective cavity in handling light rays according to the present invention;

FIG. 8 is a graph comparing relative luminance of different embodiments of the present invention to the luminance behavior of a conventional brightness enhancement film, relative to viewing angle;

FIG. 9 shows a perspective view of refractive structures that use TIR for light redirection in an alternate embodiment of the present invention;

FIG. 10 is a ray diagram showing the behavior of a solid tapered concentrator structure in handling light rays according to the present invention;

FIG. 11 is a side view of a solid concentrator structure according to the present invention, showing key parameters for determining TIR values;

FIG. 12 is an enlarged side view of a portion of a side wall of a solid concentrator structure according to the present invention, showing key dimensions of the side wall profile;

FIG. 13 shows a perspective view of optional lens structures used with the alternate embodiment of FIG. 9;

FIGS. 14a and 14b are graphs showing relative brightness effects when using a solid tapered concentrator structure without and with an output lens structure, respectively;

FIG. 15 is a schematic block diagram showing an illumination system using the brightness enhancement film of a first embodiment; and,

FIG. 16 is a schematic block diagram showing an illumination system using the brightness enhancement film of a second embodiment.

### DETAILED DESCRIPTION OF THE INVENTION

The invention is summarized above.

From one aspect, the present invention provides a brightness enhancement film comprising an array of hollow, reflective cavities extending between a light input surface and a light output surface.

From another aspect, the present invention provides a brightness enhancement film comprising an array of concentrators extending between an input aperture along a light input surface and an output aperture along a light output surface, each said concentrator having a generally parabolic shape, wherein, for each said concentrator, the area of its input aperture is less than the area of its output aperture; wherein said input surface is in contact with a light guiding plate; and, wherein each said concentrator has an index of refraction substantially equal to the index of refraction of said light guiding plate.

It is a feature of the present invention that it employs reflective properties of film structures for achieving a highly efficient redistribution of light.

It is an advantage of the present invention that it provides improved on-axis and near-axis luminance gain with respect to prior art solutions.

It is a further advantage of the present invention that it provides a single film for light redirection, without the directional bias of prior art structures. There is thus no alignment required for orientation of the brightness enhancement film of the present invention. Moreover, the brightness enhancement film of the present invention does not exhibit a directional bias, eliminating the need for providing orthogonally crossed brightness enhancement films.

It is a further advantage of the present invention that it provides uniform distribution of light in both angular and spatial domains.

It is yet a further advantage of the present invention that it allows a measure of control over light distribution angles.

It is yet a further advantage of the present invention that it provides an embodiment of a brightness enhancement film that does not require a diffuser or microstructures in the light guiding plate.

It is yet a further advantage of the present invention that it provides a compact solution for a brightness enhancement film. The film of the present invention lies directly against the light-providing surface, requiring no separation distance.

These and other objects, features, and advantages of the present invention will become apparent to those skilled in the art upon a reading of the following detailed description when taken in conjunction with the drawings wherein there is shown and described an illustrative embodiment of the invention. The present description is directed in particular to elements forming part of, or cooperating more directly with, apparatus in accordance with the invention. It is to be understood that elements not specifically shown or described may take various forms well known to those skilled in the art.

### First Embodiment: Hollow Light Collectors Employing Surface Reflection

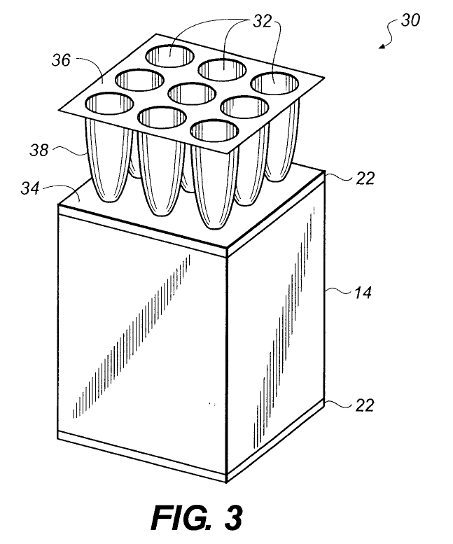

Referring to FIG. 3, there is shown a brightness enhancement film 30 of a first embodiment of the present invention, comprising an array of hollow, tapered structures. This array consists of reflective cavities 32 extending between an input surface 34 and output surface 36 and serving as light concentrators. Input surface 34 of brightness enhancement film 30 is placed against, or in very near proximity to, light-providing surface 14. Light-providing surface 14, with top and bottom diffusers 22, provides essentially Lambertian light to input surface 34. Output surface 36 then provides output illumination for an LCD (not shown) or for other backlit components.

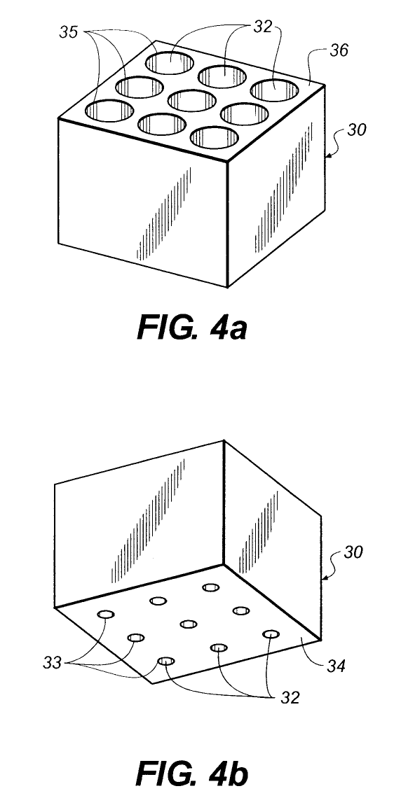

Referring to FIG. 4a, there is shown a top view, in perspective, of output surface 36 of brightness enhancement film 30, showing output apertures 35 of reflective cavities 32. Referring to FIG. 4b, a bottom view, with input apertures 33 on input surface 34, is shown.

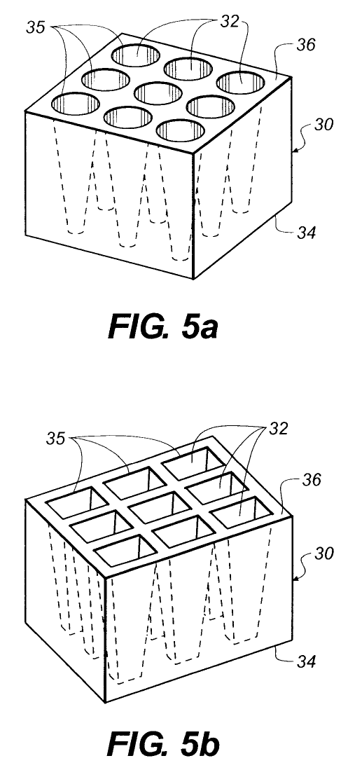

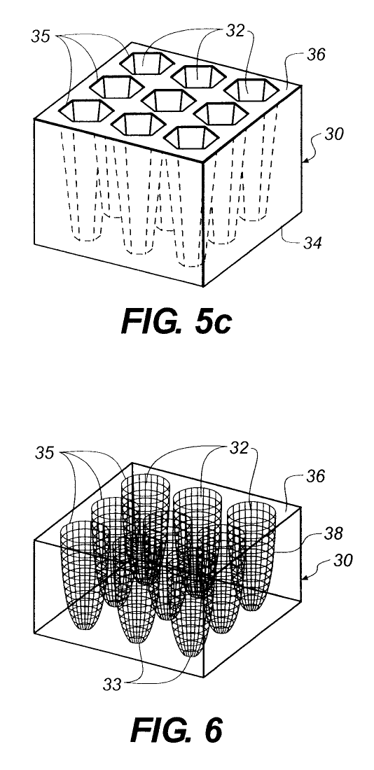

FIGS. 3, 4a, and 4b show a preferred embodiment, in which reflective cavities 32 are generally parabolic in lengthwise cross-section and circular in width-wise cross-section. As is shown in FIGS. 5a, 5b, and 5c, however, different configurations for reflective cavity 32 are possible. In FIG. 5a, reflective cavity 32 is generally cone-shaped, having a circular cross-section in the width-wise direction. In FIG. 5b, reflective cavities 32 are rectangular in width-wise cross section. In FIG. 5c, reflective cavities 32 are hexagonal in width-wise cross-section. Lengthwise cross section for the embodiments of FIGS. 5b and 5c may be parabolic, generally parabolic, or straight, for example, provided that input aperture 33 is smaller than output aperture 35.

FIG. 6 shows a wire frame view of a preferred embodiment from top perspective. In FIGS. 3, 4a, 4b, 5a, 5b, 5c and 6, reflective cavities 32 are shown extending fully through brightness enhancement film 30, from input surface 34 to output surface 36. However, there may be embodiments, using a transparent substrate for example, for which reflective cavities 32 extend only partially through brightness enhancement film 30. Thus, for example, in terms of the light path, there may be additional transparent substrate material after output aperture 35 or before input aperture 33.

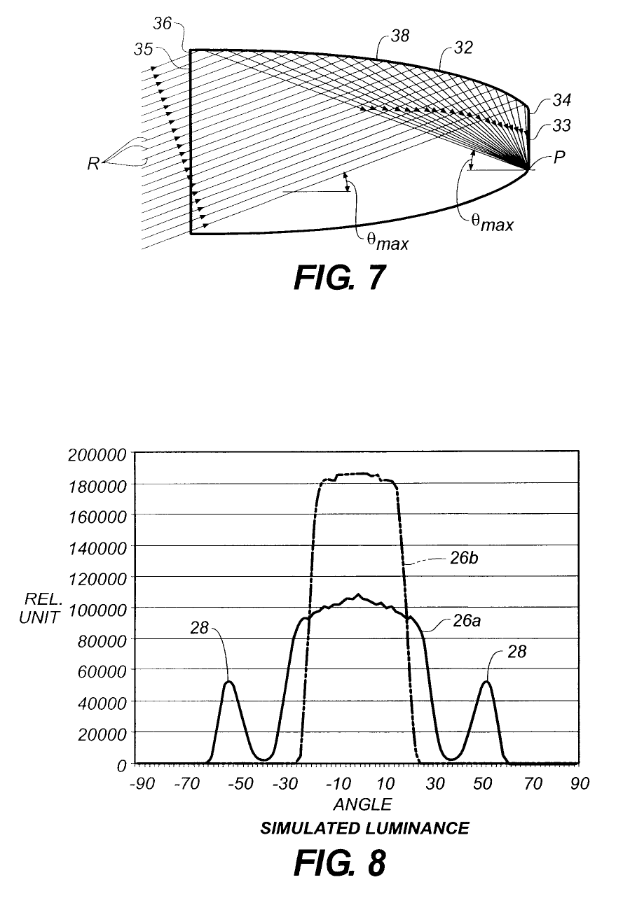

As has been noted above, for use as a light concentrator, the area of output aperture 35 must be greater than the area of input aperture 33. This typically requires reflective cavity 32 to be tapered to some degree. Provided this relationship of output aperture 35 to input aperture 33 is satisfied, reflective cavity 32 can be shaped in a number of ways. In a preferred embodiment, reflective cavity 32 is curved to have an overall rounded parabolic shape in lengthwise cross-section, as shown most clearly in the wire frame view of FIG. 6. The overall advantage of this type of shape is represented in the ray diagram of FIG. 7. When reflective cavity 32 has an idealized parabolic profile, light rays R emitted over a wide range of angles from point P on input surface 34 generally emerge at the same angle from output surface 36. Specifically, light rays from point P that reflect from a side wall 38 of reflective cavity 32 generally exit at an angle θmax that corresponds to the maximum beam angle θmax of a reflected ray from that point.

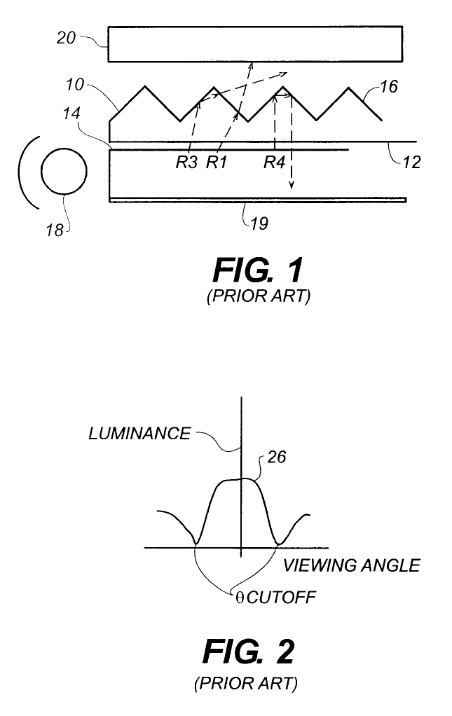

Referring to FIG. 8, there is shown a graph that compares simulated luminance curve 26b for the output luminance of brightness enhancement film 30 of the present invention with luminance curve 26a using a prior art brightness enhancement film 10, such as that shown in FIG. 1. This simulation is based on typical conditions for backlighting an LCD. Working assumptions for this simulation include a Lambertian light source, a reflectance value of 0.96, and a maximum beam angle θmax of 20 degrees. No loss from bottom diffuser 22 (FIG. 3) is assumed.

As luminance curve 26b of FIG. 8 shows, brightness enhancement film 30 of the present invention, employing an array of reflective cavities 32 as light concentrators, achieves higher on-axis luminance than is obtained using the prior art brightness enhancement film 30 solution. A substantial amount of light that is off-axis is redirected towards normal, as was shown with respect to FIG. 7. It must be noted, however, that this increase in on-axis luminance comes at a price; that is, off-axis luminance is reduced correspondingly, as is shown in FIG. 8. Thus, brightness enhancement film 30 of the present invention is optimized for applications that require a more intense on-axis illumination rather than for applications requiring increased effective viewing angle. Advantageously, when using brightness enhancement film 30 of the present invention, wasted light that caused secondary peaks 28 in prior art brightness enhancement film 10 of FIG. 1 is redirected to provide additional near-axis illumination, as is shown by comparison of luminance curves 26a and 26b in FIG. 8.

### Typical Dimensions Shape, and Fabrication for First Embodiment

Typical values for reflective cavity 32 in the first embodiment of brightness enhancement film 30 include the following:

Output aperture 35 diameter: 400 um

Input aperture 33 diameter: 140 um

Height: 720 um

Reflectance: 0.96, nominal

Typical maximum beam angle θmax: 20 degrees

In this first embodiment, brightness enhancement film 30 may be formed from metallic or plastic materials, including polycarbonate, polymethyl methacrylate (PMMA), or acrylic film, for example. Where the material is reflective, no coating may be needed. When using transparent material or a material that is not sufficiently reflective, such as a metal surface, a reflective coating is applied to the inner surfaces of reflective cavity 32 and, optionally, to other parts of the structure. Fabrication techniques for forming reflective cavities 32 themselves include drilling and etching.

FIGS. 4a, 4b, 5a, 5b, 5c, and 6 show various arrangements of the structure supporting reflective cavities 32. Most of these embodiments have some support structure at input surface 34 and at output surface 36. However, as is shown in FIG. 5b, one or the other of input and output surfaces 34 or 36 may not use supporting structure material between individual reflective cavities 32. In the hexagonal output aperture 35 of FIG. 5c, side walls of adjacent reflective cavities 32 are shared. This arrangement both provides a sturdy structure at output surface 36 and allows maximum area of output aperture 35.

In a preferred embodiment, reflective cavity 32 is round, taken in horizontal cross-section (that is, in a cross-section parallel to the output surface of brightness enhancement film 30 ). However, other shapes are possible, allowing reflective cavity 22 to have a square or rectangular cross-sectional shape, for example. In general, non-circular cross-sectional shapes can favorably increase the fill factor of brightness enhancement film 30. At the same time, it must be observed that the overall fill factor at output surface 36, that is, the area of output aperture 35 (FIGS. 4-7 ) must be carefully considered in order to maintain sufficient supporting structure for brightness enhancement film 30.

For the preferred embodiment, an overall parabolic vertical cross-sectional shape is most highly advantaged for reflective cavity 32, due to the handling of light, as was described with reference to FIG. 7. The overall shape of a compound parabolic concentrator (CPC) is the preferred shape for side wall 38 of reflective cavity 32. It must be noted, however, that reflective side wall 38 may be substantially vertical (that is, having no defined slope) or may have a fixed or variable slope. For this first embodiment, as noted hereinabove, reflective cavity 32 must satisfy the requirement that the area of input aperture 33 is less than that of output aperture 35.

Non-uniform size, shape, and distribution of reflective cavities 32 may be suitable for providing uniform light output. Thus, for example, a film using an array of reflective cavities 32 may require different sizes and distributions of reflective cavities 27 for different embodiments.

### Second Embodiment: Solid Light Collectors Employing TIR Effects

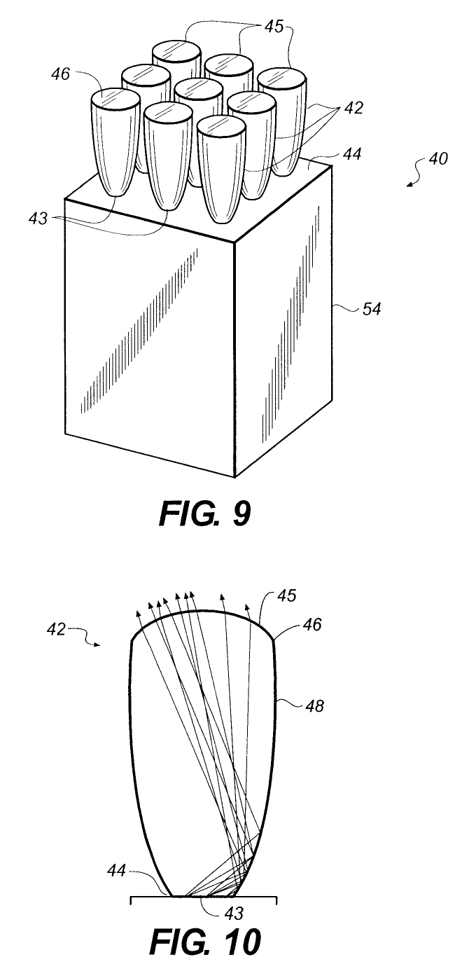

Referring to FIG. 9, there is shown a second embodiment of the present invention, wherein a brightness enhancement film 40 comprises an array of solid, tapered structures. Similar to the tapered, generally columnar structures of the first embodiment of FIGS. 3-7, the embodiment shown in FIG. 9 also takes advantage of a generally parabolic shaped structure for conditioning light using reflection, but employs a different reflective principle. Here, brightness enhancement film 40 uses a tapered array of solid parabolic concentrators 42. Unlike reflective cavities 32 of the first embodiment, solid parabolic concentrators 42 do not require a reflective inner coating. Instead, each parabolic concentrator 42 uses Total Internal Reflection (TIR) to direct light from an input aperture 43 to an output aperture 45. As is shown in FIG. 9, input surface 44 of each parabolic concentrator 42 is placed against a light guiding plate 54. For this embodiment, the following special requirements must be met:
(i) the material used to form parabolic concentrator 42 has substantially the same index of refraction n as that of light guiding plate 54, to within about ±0.1;
(ii) light guiding plate 54 for this embodiment does not provide a diffuser;
(iii) input aperture 43 of parabolic concentrator 42 is in direct contact with light guiding plate 54, that is, input aperture 43 lies against light guiding plate 54 without any air gap. Input aperture 43 may be glued, pressed into, molded onto, or otherwise attached to the surface of light guiding plate 54, for example.
   For this embodiment, light guiding plate 54, a type of light pipe, also requires a reflective surface opposite its light source, using a configuration well known to those skilled in the art of LCD backlighting techniques. Referring ahead to FIG. 16, a suitable arrangement for light guiding plate 54 is shown, with a reflective surface 24 opposite light source 18 and with external surfaces joined at right angles.

Referring to FIG. 10, the overall behavior of solid parabolic concentrator 42 is shown for light rays R from different origins at input aperture 43 along input surface 44. In a manner similar to that shown for the first embodiment using reflective cavities 32 and represented in FIG. 7, the preferred curvature of an inner side wall 48 is generally parabolic, so that light incident at input aperture 43 over a range of angles is reflected from side wall 48 due to TIR and is output at an output aperture 45 on output surface 46. As was also noted with reference to the first embodiment, input aperture 43 must be smaller in area than output aperture 45.

### Defining Surface Curvature of Side Wall 48

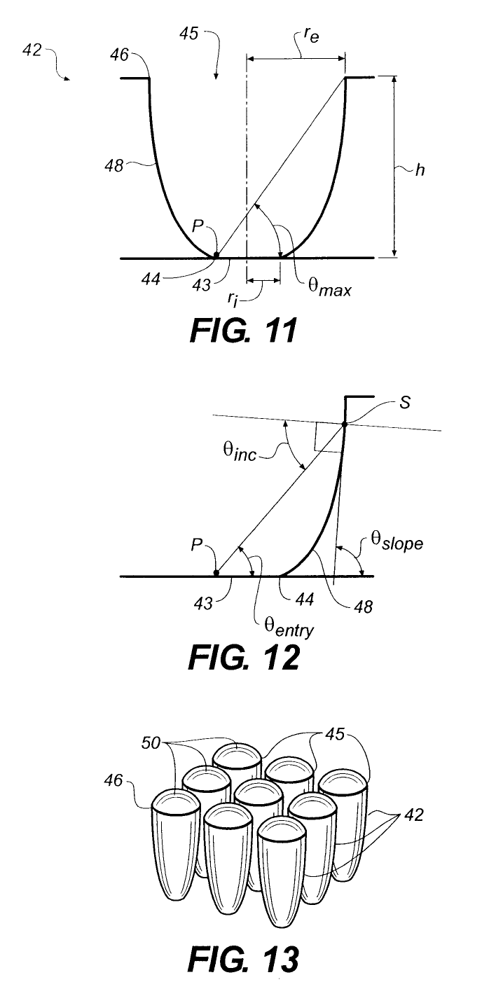

For solid parabolic concentrator 42 of the second embodiment, the surface profile of side-wall 48 determines how total internal reflection (TIR) redirects light from light-providing surface 14. Referring to FIG. 11, the outline of side-wall 48 of parabolic concentrator 42 is shown in vertical cross-section. For the purposes of this description, it is assumed that a horizontal (that is, width-wise) cross-section view of parabolic concentrator 42 is circular, although other shapes could be used. On input surface 44, input aperture 43 of parabolic concentrator 42 has radius rᵢ. On output surface 46, output aperture 45 has radius rₑ. Value h represents the height of parabolic concentrator 42. The maximum angle at which TIR can occur, from a reference point P on the circumference of the input aperture, is θₘₐₓ, defined by equation (1):

$${θ}_{max} = {tan}^{- 1} ( \frac{h}{{r}_{input} + {r}_{output}} ) \qquad ( 1 )$$

By way of review, TIR is achieved when critical angle θ_{TIR} for incident light is exceeded as defined in equation (2), where n is the index of refraction of the material used for parabolic concentrator 42:

$${θ}_{TIR} = {sin}^{- 1} ( \frac{1}{n} ) \qquad ( 2 )$$

Key angular relationships for design of side-wall 48 curvature in order to use TIR are shown in FIG. 12. Here, angle θₛₗₒₚₑ represents the slope of side-wall 48 at a point S. Angle θ_{inc} represents the incident angle for light from point P, relative to normal at point S. For maintaining TIR for light from point P at each point S on side wall 48, the relationship of equation (3) must hold:
θ_{inc}=90°−(θₛₗₒₚₑ−θ_{entry})≧θ_{TIR} (3)
It can be observed that a generally parabolic shape satisfies equation (3) and provides the general light re-direction behavior shown in FIG. 10.

Based on the above descriptions and equations (1)-(3), the following steps are used to establish the desired profile for side-walls 48 in the second embodiment:
(Step 1) Define the following parameters of parabolic concentrator 42:
   (a) Input aperture rᵢₙₚᵤₜ
   (b) Height h
   (c) angle θₘₐₓ
(Step 2) Calculate the radius of the output aperture, rₒᵤₜₚᵤₜ, using equation (1).
(Step 3) Determine slope angle θₛₗₒₚₑ at a number of successive points S along side-wall 44 (FIG. 12), using equation (3).

As with brightness enhancement film 30 of the first embodiment, brightness enhancement film 40 of the second embodiment redirects light toward normal, as was described with respect to FIG. 10.

### Adding a Lens Structure

Referring to FIG. 13, there is shown an alternate configuration of output aperture 45 on a portion of output surface 46 of parabolic concentrator 42. In this configuration, a lens 50 is formed on output aperture 45 of one or more parabolic concentrators 42, providing improved redirection of light from light-providing surface 14.

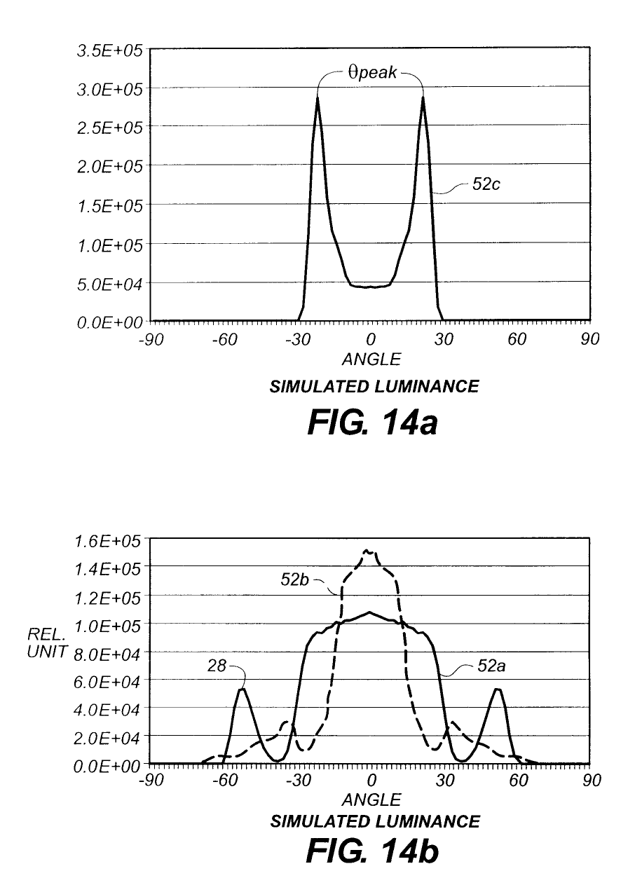

Equation (4) describes the radius of curvature for lens 50.

$$Radius of Curvature = \frac{{r}_{out}}{2 tan ( {φ}_{peak} )} \qquad ( 4 )$$

where rₒᵤₜ is the radius of exit aperture 45 and φₚₑₐₖ is an angle at which peak intensity occurs without lens 50, as is shown in FIG. 14a.

Referring to FIG. 14b , there are shown, for comparison, luminance curve 52a for the conventional BEF solution shown in FIG. 1 and luminance curve 52b for brightness enhancement film 40 of this second embodiment using solid parabolic concentrators 42 with lens 50. Comparison of luminance curve 52b of FIG. 14b with luminance curve 52c in FIG. 14a shows how lens 50 conditions the light at output aperture 45, effectively collecting light into a single lobe, centered about 0 degrees (normal to the BEF surface).

### Typical Dimensions Shape, and Fabrication for Second Embodiment

Typical values for solid parabolic concentrator 42 in the second embodiment of brightness enhancement film 40 include the following:

Output aperture 45 diameter: 400 um

Input aperture 43 diameter: 140 um

Height: 720 um

Typical maximum beam angle θₘₐₓ: 20 degrees

Brightness enhancement film 40 with parabolic concentrators 42 may be formed from a variety of plastic materials, including polycarbonate, PMMA, or acrylic film, for example. The density of parabolic concentrators 42 depends on the application. For providing improved spatial uniformity, the spacing or center-to-center pitch of parabolic concentrators 42, as well as their input and output aperture 43 and 45 dimensions and overall shape, may be non-uniform across brightness enhancement film 40. For example, parabolic concentrators 42 may be more densely clustered at locations further from the light source than at locations near the light source.

### Improved Illumination Systems

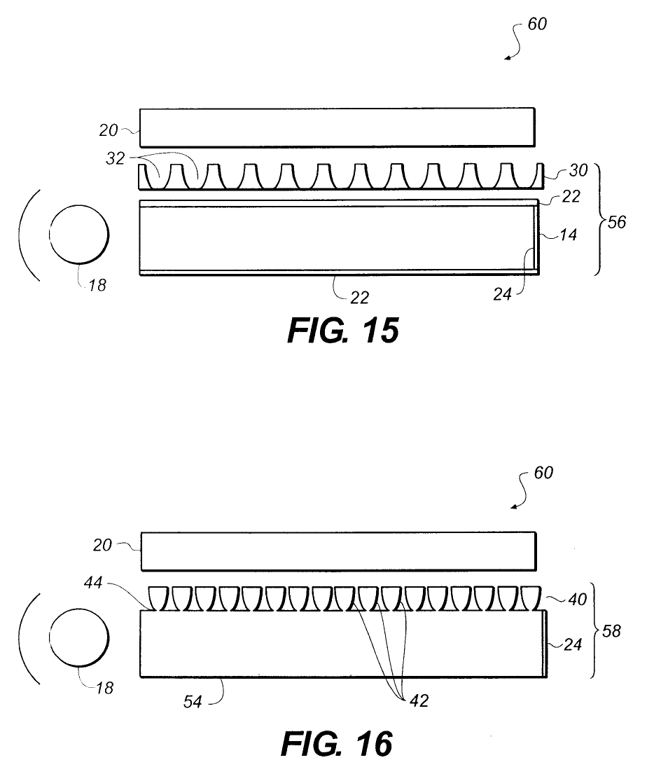

Referring to FIG. 15, there is shown, for a display apparatus 60, an illumination system 56 employing brightness enhancement film 30 of the first embodiment for providing light to LCD component 20. Light providing surface 14 with top and bottom diffusers 22 and reflective surface 24 provides Lambertian scattered light from light source 18 to brightness enhancement film 30. The conditioned output from brightness enhancement film 30 is then directed through LCD component 20.

Referring to FIG. 16, there is shown, for display apparatus 60, an illumination system 58 employing brightness enhancement film 40 of the second embodiment for providing light to LCD component 20. Light providing surface 54, with reflective surface 24, provides incident light at suitable angles for conditioning by brightness enhancement film 40. Input surface 44 of brightness enhancement film 40 is pressed, adhered, or otherwise formed directly against light providing surface 54. The output light is then directed through LCD component 20. (Diffusers 22 are not required with this second embodiment.)

As was noted in the background section hereinabove, prior art solutions using brightness enhancement film 10 have a directional bias, requiring the use of two film sheets having orthogonal preferred angles in most applications. It can be seen that brightness enhancement films 30 and 40 enjoy an advantage over prior art designs with respect to the absence of such directional bias across the film sheet. With generally circular reflective cavities 32 or parabolic concentrators 42, there is no need for using multiple brightness enhancement films 30 or 40 to handle light at different angles.

For both hollow and solid embodiments, the primary conditioning of incident light is provided by reflection from side-walls 38 (first embodiment) or 48 (second embodiment). With the first embodiment of FIGS. 3-7, some light passes directly through the hollow reflective structure of reflective cavity 32 without reflection from side-wall 38. In contrast, with the second embodiment of FIGS. 9-12, very little light is able to pass through solid parabolic concentrator 42 without reflection from side-wall 48.

### Uses for Area Lighting Applications

The above description focused primarily on use of brightness enhancement films 30 and 40 of the present invention in backlit display applications. However, the array of tapered structures used in either first or second embodiments of the present invention could also be used in area lighting applications. The capability of these arrays to accept light at a broad range of angles and redirect that light toward a normal axis suggests a range of possible uses, such as for reading lamps and surgical lighting apparatus, for example. Brightness enhancement films 30 and 40 of the present invention are particularly well-suited to lighting applications employing a generally Lambertian light source.

The invention has been described with reference to a preferred embodiment; however, it will be appreciated that variations and modifications can be effected by a person of ordinary skill in the art without departing from the scope of the invention. For example, while the idealized parabolic shape has particular advantages, approximations to parabolic are also effective for redirection of light toward the normal axis, with either the hollow, reflective first embodiment of FIGS. 3-7 or with the solid second embodiment of FIGS. 9-13. For the first reflective embodiment, various types of coatings could be applied to a transparent or non-reflective substrate in order to obtain suitable reflective properties. For the second reflective embodiment, parabolic concentrators 42 could be molded or otherwise formed into the surface of light guiding plate 54, so that brightness enhancement film 40 is effectively fabricated as a part of light guiding plate 54.

The brightness enhancement film of the present invention directs off-axis light toward a normal axis relative to the film surface and is, therefore, particularly well-suited for use with LCD display devices and for other types of backlit displays.

### PARTS LIST

10. Brightness enhancement film
12. Smooth side
14. Light-providing surface
16. Prismatic structures
18. Light source
19. Reflective surface
20. LCD component
22. Diffuser
24. Reflective surface
26, 26a, 26b. Luminance curve
28. Secondary peaks
30. Brightness enhancement film
32. Reflective cavities
33, 43. Input aperture
34. Input surface
36. Output surface
38, 48. Side wall
40. Brightness enhancement film
42. Parabolic concentrator
44. Input surface
35, 45. Output aperture
46. Output surface
50. Lens
52a, 52b, 52c. Luminance curve
54. Light guiding plate
56, 58. Illumination system
60. Display apparatus

1. An illumination system comprising:
(a) a light guiding plate for providing a generally Lambertian light source and
(b) a brightness enhancement film comprising an array of tapered structures extending from the light input to the light output surface of the film, each said tapered structure having a light input aperture and a larger light output aperture, wherein the inner surface of each said tapered structure is adapted to reflect off-axis light incident at said input aperture to said output aperture in which said array of tapered structures comprises an array of concentrators extending between an input aperture on the input surface and an output aperture on the output surface, each said concentrator having a generally parabolic shape taken from said light input aperture to said light output aperture.

2. The illumination system of claim 1 comprising A brightness enhancement film according to claim 1 wherein said input surface is in contact with a light guiding plate; and each said concentrator has an index of refraction substantially equal to the index of refraction of said light guiding plate.

3. The illumination system of claim 1 wherein the structures are hollow.

4. The illumination system of claim 3 wherein the side-wall of at least one of said reflective cavities comprises a reflective coating.

5. The illumination system of claim 3 wherein at least two of said hollow, reflective cavities differ dimensionally from each other.

6. The illumination system of claim 1 wherein said input surface comprises a transparent substrate.

7. The illumination system of claim 1 wherein said output surface comprises a transparent substrate.

8. The illumination system of claim 1 wherein the film comprises a reflective substrate.

9. An illumination system according to claim 3 wherein, in a cross-section parallel to said output surface of said brightness enhancement film, at least one said reflective cavity is substantially circular.

10. An illumination system according to claim 1 wherein, in a cross-section parallel to said output surface of said brightness enhancement film, at least one said reflective cavity is substantially circular.

11. An illumination system according to claim 1 wherein, in a cross-section parallel to said output surface of said brightness enhancement film, at least one said reflective cavity is substantially rectangular.

12. An illumination system according to claim 1 wherein, in a cross-section parallel to said output surface of said brightness enhancement film, at least one said reflective cavity is substantially hexagonal.

13. An illumination system according to claim 1 wherein the index of refraction is of the structures is substantially equal to the index of refraction of said light guiding plate.

14. An illumination system according to claim 1 wherein a lens is formed at said output aperture for at least one said concentrator.

15. An illumination system according to claim 1 wherein total internal reflection within each said concentrator directs a portion of off-axis light from said input aperture to said output aperture.

16. A method for enhancing luminance for a backlit display, comprising:
(a) providing a light guiding surface having a first index of refraction n1;
(b) forming an array of tapered concentrators, each concentrator having a generally parabolic shape, wherein:
(1) the input aperture of each said concentrator is smaller than the output aperture;
(2) each said concentrator has a second index of refraction n;, and
(3) n2 is substantially equal to n1;
(c) disposing the input aperture of a plurality of said concentrators against said light guiding surface.

17. A method for enhancing luminance for a backlit display according to claim 16 wherein the step of disposing the input aperture of a plurality of said concentrators against said light guiding surface comprises the step of applying an adhesive to an input surface of said array of tapered concentrators.

18. A method for enhancing luminance for a backlit display according to claim 16 wherein the step of disposing the input aperture of a plurality of said concentrators against said light guiding surface does not comprise the step of applying an adhesive to an input surface of said array of tapered concentrators.
